(19) United States
(12) Patent Application Publication
(10) Pub. No.: US 2012/0237144 A1
(43) Pub. Date: Sep. 20, 2012

(54) RAIL SYSTEM FOR DRAWERS

(76) Inventor: Ingo GASSER, Hoechst (AT)

(21) Appl. No.: 13/487,534

(22) Filed: Jun. 4, 2012

Related U.S. Application Data
(63) Continuation of application No. PCT/AT2010/000424, filed on Nov. 8, 2010.

(30) Foreign Application Priority Data
Dec. 23, 2009 (AT) A 2028/2009

(51) Int. Cl. F16C 29/00

(52) U.S. Cl. 384/7

(57) ABSTRACT

The invention relates to a rail system (4) for drawers (3), comprising a body rail (6) to be fastened to a furniture body (2) and at least one drawer rail (7) that can be moved relative to the body rail (6), and comprising at least one gear rack (9) arranged on a rail (6, 7, 10) of the rail system (4), wherein the gear rack (9) can be pivoted or bent relative to the rail (6, 7, 10) to which said gear rack is fastened about an imaginary axis (A) extending in the pull-out direction (13) of the rail (6, 7, 10) and thus is mounted such that the gear rack can be moved vertically to a limited extent.

The present invention concerns a rail system for drawers, comprising a carcass rail to be fastened to a furniture carcass and at least one drawer rail movable relative to the carcass rail, and at least one rack arranged on a rail of the rail system.

The invention further concerns an arrangement of two rail systems of the kind to be described, which are to be mounted at opposite side walls of an article of furniture and which are connected together for the transmission of a synchronous movement by way of a synchronisation bar.

Such rail systems are usually employed to synchronise the movement of two drawer extension guides which are in opposite relationship on an article of furniture, relative to each other, by a rack-and-pinion arrangement. That permits precise parallel guidance of an extendable furniture part—in particular of a drawer. That parallel guidance relative to a furniture carcass is advantageous in particular when very narrow or very wide drawers are to be moved, in which case lateral tilting of the drawer is substantially prevented by the parallel guidance effect. The movement of the oppositely disposed rail systems is frequently synchronised by way of a synchronisation bar extending transversely to the extension direction. Mounted at both end regions of the synchronisation bar are pinions which respectively engage into the racks of the rail systems to be synchronised. EP 1 036 526 B1 to the present applicant discloses such a parallel guide assembly having a rack-and-pinion arrangement. With known rail systems the problem can sometimes occur that the positively locking connection between the rack and the pinion can lead to jamming of the rail system and thus unwanted blocking of the drawer in normal use.

DE 43 01 326 A1 describes a drawer extension arrangement, wherein toothed racks are mounted movably on the carcass rail and the drawer rail so that they can project freely over their length from the respective fastening end. The flexural axis of the rack extends in that case substantially at a right angle to the extension direction of the rails.

The object of the present invention is to propose a rail system of the general kind set forth in the opening part of this specification, having improved running properties.

According to the invention, that is attained by the features of claim 1. Further advantageous configurations of the invention are recited in the appendant claims.

Thus it is provided that the rack is pivotable or bendable with respect to the rail to which it is fastened about a notional axis extending in the extension direction of the rail and is thus mounted limitedly movably heightwise.

A limitedly heightwise movable mounting of the rack provides that, when pulling out and pushing in the drawer, it is possible to avoid twisting between the pinion and the rack, as the rack which is mounted resiliently in a heightwise direction can yield with respect to the pinion in possible jamming situations, in which case however the positively locking connection between the pinion and the rack is maintained. The rack can therefore be elastically preloaded towards the pinion, either by inherent elasticity or also by the force of a spring.

In an embodiment it can be provided that the rack is mounted limitedly movably heightwise by way of a resiliently yielding portion. The resiliently yielding region is such that, after vertical deflection, the rack is automatically moved back into the original starting position again.

In an embodiment of the invention it can be provided that the rack is connected to one of the rails by way of a film hinge. Such an integral hinge connection between the rack and the stationary or heightwisely immobile part of the rail can be implemented by a thin-wall connection (for example by a groove extending in a longitudinal direction of the rail). It is equally advantageously possible to use a flexural hinge by which the rack is pivotable about a longitudinal axis.

In a possible development of the invention it can be provided that the rack is arranged or provided on an adaptor, wherein the adaptor is connected or can be releasably connected to one of the rails by way of at least one fastening location. In that respect it may be desirable if the adaptor is substantially in the form of an L-profile, wherein in the mounted position one leg of the L-profile bears against a vertical limb of the carcass rail and another leg of the L-profile bears against a horizontal limb of the carcass rail. Simple fastening can be effected by the adaptor being fastened at the same time as mounting of the rail system to the furniture carcass.

It is to be noted that there is provided at least one pinion engaging into the rack of the rail system. The pinion engaging into the rack can be directly or indirectly coupled to the synchronisation bar, as a parallel guidance pinion. In particular there can be a non-rotatable connection between the pinion and the synchronisation bar.

In a first embodiment it is provided that the rack is arranged on the carcass rail or the furniture carcass and the pinion is mounted on the drawer rail or the drawer. In an alternative embodiment, it can be provided that the rack is arranged on the drawer rail or the drawer and the pinion is mounted on the carcass rail or the furniture carcass.

Further details and advantages of the present invention are described by means of the specific description hereinafter. In the drawing:

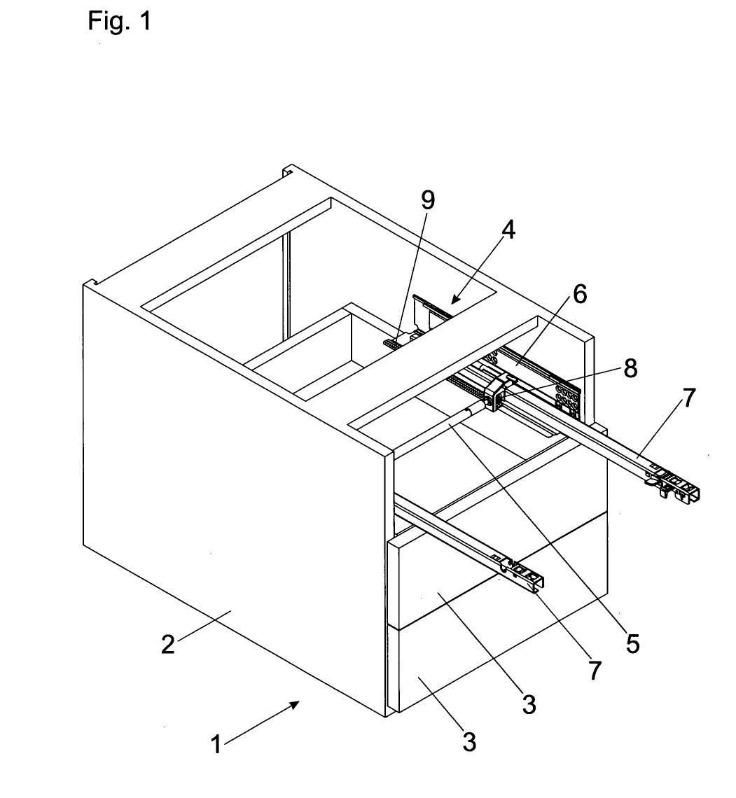

FIG. 1 shows a perspective view of an article of furniture with drawers which are mounted displaceably relative to a furniture carcass by way of oppositely disposed rail systems,

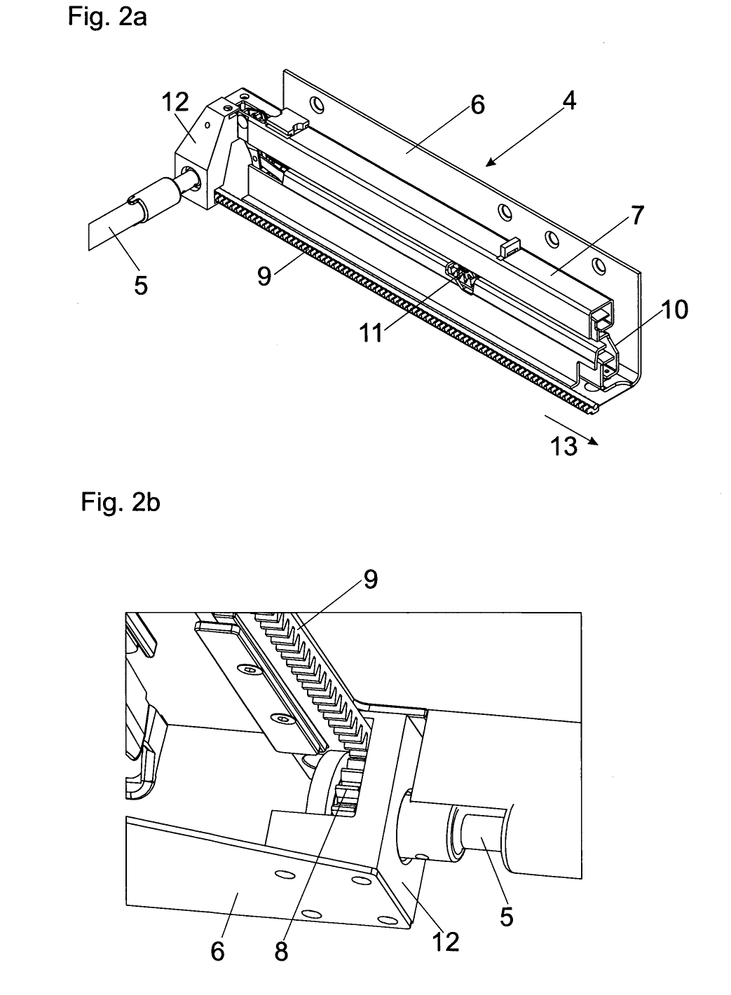

FIGS. 2a, 2b show a perspective view of a rail system, wherein the rack provided for synchronisation of the movement of the drawer is arranged on the carcass rail, and a perspective view of a rack arranged on the drawer,

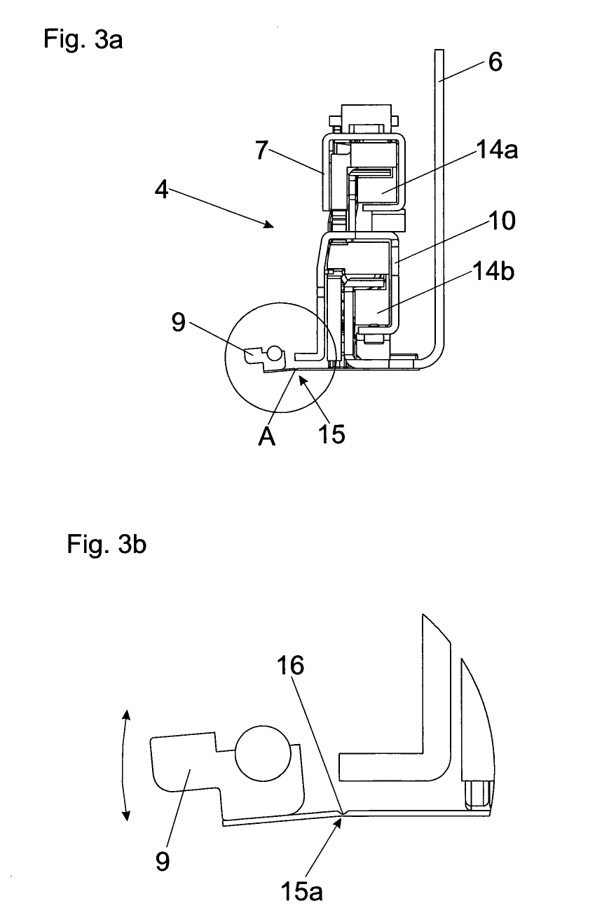

FIGS. 3a, 3b show a sectional view of the rail system, wherein the rack is connected to the carcass rail by way of a film hinge, and an enlarged detail view thereof,

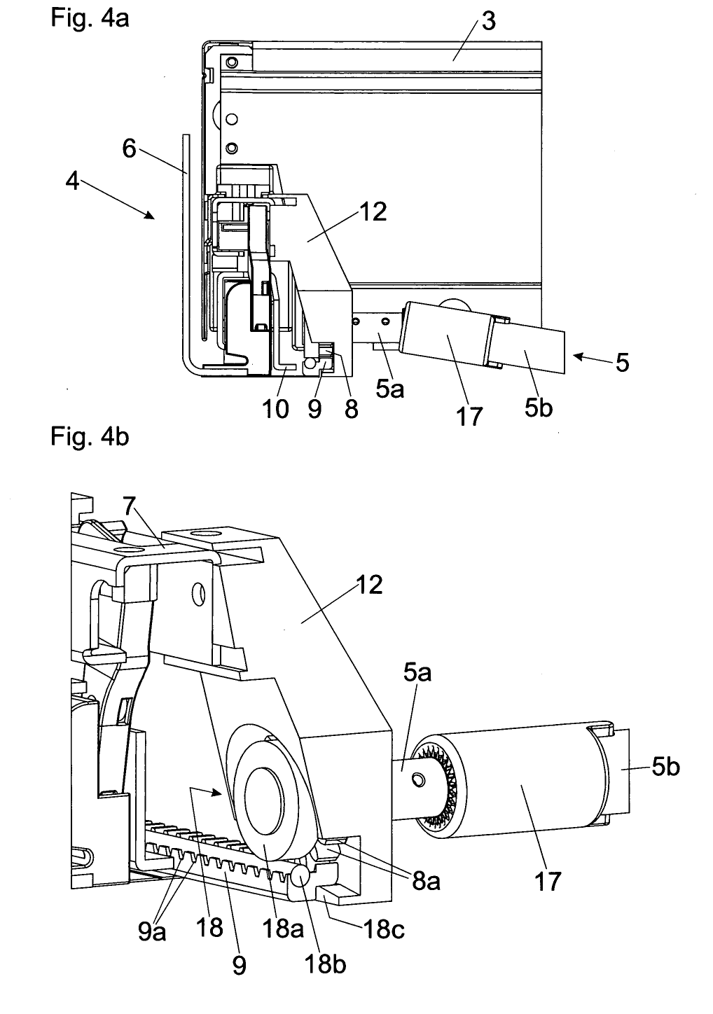

FIGS. 4a, 4b show a view from the rear and a perspective view of the rail system,

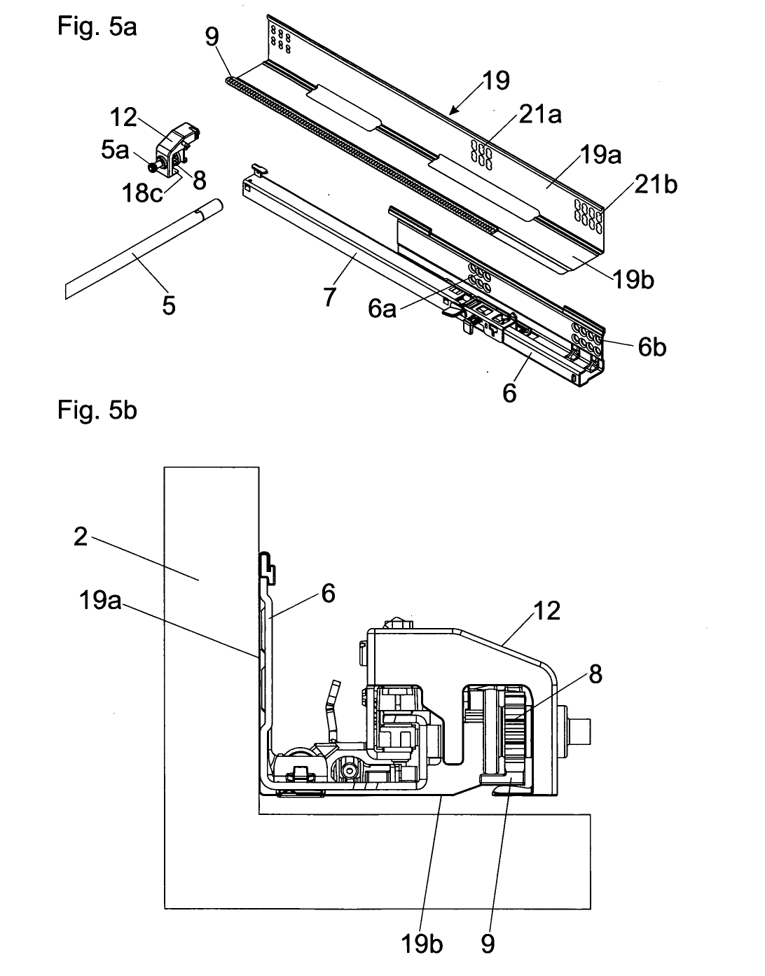

FIGS. 5a, 5b show an embodiment of the invention with an adaptor carrying the rack as a perspective exploded view and the mounted position of the rail system as a sectional view, and

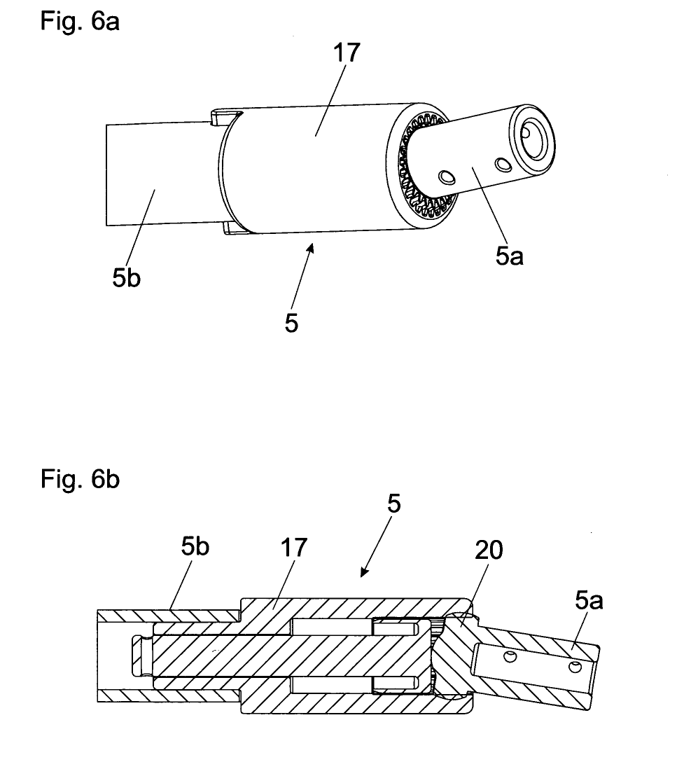

FIGS. 6a, 6b show a possible embodiment of a synchronisation bar provided for synchronising a movement of two rail systems in opposite relationship on a furniture carcass, wherein the synchronisation bar has a hinge.

FIG. 1 shows a perspective view of an article of furniture 1 having a furniture carcass 2 in cabinet form, with drawers 3 mounted displaceably relative to the furniture carcass 2 by way of rail systems 4. Disposed on each side of the drawer 3 is a rail system 4, wherein the two rail systems 4 are to be fastened to mutually opposite side walls of the furniture carcass 2. It is possible to see a synchronisation bar 5 in the form of a torsion shaft, extending transversely relative to the extension direction of the drawer 3. The movements of the two rail systems 4 can be synchronised relative to each other by the synchronisation bar 5 whereby it is also possible to provide for precise parallel guidance of the drawer 3 relative to the furniture carcass 2. The two rail systems 4 respectively have a carcass rail 6 to be mounted to the furniture carcass 2 and at least one drawer rail 7 displaceable relative to the carcass rail 6. The purpose of the synchronisation bar 5 is to synchronise a movement of the left-hand and right-hand drawer rails 7 relative to each other so that the drawer 3 can be pulled out of the furniture carcass 2 and pushed thereinto without lateral tilting. At the end regions the synchronisation bar 5 has at least one rotatably mounted pinion 8 meshing with a rack 9 of the rail system 4. It will be appreciated that as a mechanical reversal it is also possible for the rack 9 to be mounted to the drawer 3 or to the drawer rail 7 and for the associated pinion 8 to be mounted to the carcass rail 6 or the furniture carcass 2.

FIG. 2a shows a perspective view of a rail system 4 with the carcass rail 6 to be fastened to the furniture carcass 2 and the displaceable drawer rail 7. A middle rail 10 is mounted displaceably between the carcass rail 6 and the drawer rail 7 in known manner in order in that way to permit full extension of the drawer 3 relative to the furniture carcass 2. For synchronisation of the rail movement of an individual rail system 4, there is provided a synchronisation device 11 with a pinion mounted rotatably to the middle rail 10 and which can control the movable rails 7, 10 relative to each other in accordance with a progressive action slide, so that the drawer rail 7 moves at approximately twice the speed of the middle rail 10. A mounting block 12 is fixedly connected to the extendable drawer rail 7. The pinion 8 shown in FIG. 1 which engages into the rack 9 is accommodated in that mounting block 12. The rack 9 extends in the extension direction 13 of the drawer 3 and extends substantially over the entire length of a rail 6, 7, 10, in the present case over the entire length of the carcass rail 6. It will be appreciated that it would also be possible for the rack 9 to also extend only over a part of the length of a rail 6, 7, 10. When the drawer 3 is pulled out in the extension direction 13, the drawer rail 7 is moved forwardly together with the mounting block 12 arranged thereon and together with the synchronisation bar 5 along the rack 9, with the pinion 8 also running along the rack 9. The movement of the pinions 8 of two rail systems 4 in opposite relationship on a furniture carcass 2 can be synchronised by the synchronisation bar 5.

FIG. 2b only diagrammatically shows the mechanical reversal thereof, namely, showing that the mounting block 12 with the pinion 8 is mounted to the carcass rail 6 (or alternatively to the furniture carcass 2) and the rack 9 is mounted to the drawer rail 7 (or also to the drawer 3).

FIG. 3a shows a vertical section through the rail system 4 with the stationary carcass rail 6, the middle rail 10 movable relative thereto and the drawer rail 7. Displaceable running carriages 14a, 14b with load-transmitting rolling bodies are mounted between the rails 6, 7, 10. In the illustrated embodiment the rack 9 is connected by way of a resilient region 15 to the stationary part of the carcass rail 6. FIG. 3b shows an enlarged view of the region circled in FIG. 3a. The resiliently yielding region 15 is embodied in the illustrated embodiment by a film hinge 15a, that is to say by a local weakening in the rail 6, extending in the longitudinal direction of the rail 6, 7, 10, in the form of a groove 16, thereby providing for partial flexibility of the rack 9 in an upward direction. The risk of jamming as between the pinion 8 and the rack 9 can be substantially reduced in that way. The heightwisely movable mounting of the rack 9 can also be implemented by way of a flexural hinge so that the rack 9 is mounted limitedly heightwisely movably as indicated by the illustrated double-headed arrow. The rack 9 is thus pivotable or bendable with respect to the rail 6 about a notional axis (A) extending in the extension direction 13 (FIG. 2a) and is thus mounted limitedly movably heightwise. It is to be noted that the hinge or axis (A) does not have to be at a well-defined location (for example by a weakening of the film hinge). Rather the rack 9 can be of an elastically bendable configuration in itself and can thus bend downwardly at the free longitudinal edge.

FIG. 4a shows a view from the rear of the drawer 3 connected to the rail system 4. The mounting block 12 is fixedly connected to the drawer rail 7, the pinion 8 engaging into the rack 9 connected to the carcass rail 6. The rotary movement of the pinions 8 of two rail systems 4 in opposite relationship on a furniture carcass 2 is synchronised relative to each other by the synchronisation bar 5. In the illustrated embodiment the synchronisation bar 5 is of a two-part structure and includes two shaft portions 5a and 5b connected together by way of a joint 17. The joint 17 of the synchronisation bar 5 makes it possible to compensate for installation tolerances, height errors and possible angular displacement of two oppositely disposed rail systems 4. The joint 17 is of such a construction that a rotary movement of the two shaft portions 5a, 5b relative to each other is possible.

FIG. 4b shows a perspective view from the rear of the rail system 4 in the closed position. The rail system 4 has a limiting device 18 which limits the depth of engagement of the pinion 8 relative to the rack 9 in such a way that the teeth 8a of the pinion 8 only partially engage into the corresponding tooth gaps 9a in the rack 9. The limiting device 18 includes a runner wheel 18—preferably in the form of a friction wheel—which is mounted rotatably coaxially relative to the pinion 8. The diameter of the runner wheel 18a is smaller than that of the pinion 8. It is possible to see a—preferably elastically yielding—part 18b which can extend substantially over the entire length of the rack 9. The runner wheel 18a runs on or along a running surface of the part 18b which is made of plastic material, whereby the teeth 8a of the pinion 8 cannot engage completely into the tooth gaps 9a in the rack 9. That makes it possible to effectively prevent jamming as between the pinion 8 and the rack 9, thereby also preventing the risk of jamming of the drawer 3 in normal use. The limiting device 18 also includes a limb 18c which engages under the rack 8 and by which the lift-off height of the pinion 8 relative to the rack 9 can be limited. In the illustrated embodiment the limb 18c is part of the mounting block 12 and can be moved along the stationary rack 9 upon movement of the drawer 3. The plastic part 18b acts virtually as a cushion between the pinion 8 and the rack 9 whereby the pinion 8 is guided in a play-free fashion and with a low level of noise.

FIG. 5a shows an exploded view of a rail system 4, wherein the rack 9 is provided on a substantially L-shaped adaptor 19. The adaptor 19 includes two legs 19a and 19b substantially arranged at a right angle to each other, the rack 9 being mounted on the leg 19b. The adaptor 19 is also suitable in particular for equipping a commercially available extension guide for drawers 3—comprising a carcass rail 6 and at least one drawer rail 7 displaceable relative thereto—with a rack 9, as from the factory, or also subsequently. The adaptor 19 can be made from plastic material or metal. The adaptor has fastening locations 21a and 21b aligned with the fastening locations 16a, 16b of the carcass rail 6. In the mounting operation therefore screws are passed through the fastening locations 6a, 6b of the carcass rail 6 and through the fastening locations 21a, 21b of the adaptor 19 and screwed into the furniture carcass 2. The fastening locations 21a, 21b of the adaptor 19 are only possible configurations, in particular it is also possible to provide a snap connection between the adaptor 19 and the rail system 4.

FIG. 5b shows the carcass rail 6 of FIG. 5a, fastened to the furniture carcass 2. In the mounting operation the leg 19a of the adaptor 19 is screwed between the carcass rail 6 and the furniture carcass 2. The lower leg 19b of the adaptor is resilient so that the rack 9 mounted thereon is mounted limitedly heightwisely movably in order thus to prevent jamming as between the pinion 8 and the rack 9 during the movement of the drawer 2.

FIG. 6a shows an embodiment of a synchronisation bar 5 provided for synchronisation of two rail systems 4 in opposite relationship on a furniture carcass 2. The synchronisation bar 5 is of a two part configuration and includes two shaft portions 5a and 5b connected together by way of a joint 17. The joint 17 permits radial mobility of the two shaft portions 5a and 5b relative to each other. The joint 17 can be in the form of a shaft joint, in particular a cardan joint or a ball joint. It is possible in that way to compensate for the relative displacement of two rail systems 4 in opposite relationship on a furniture carcass 2. FIG. 6b shows a sectional view of the synchronisation bar 5 with the two shaft portions 5a, 5b of FIG. 6a. It is possible to see the gear head 20 which is arranged on the shaft portion 5a and which engages into a corresponding tooth arrangement of the joint 17.

The present invention is not limited to the illustrated embodiments but includes or extends to all technical equivalents which can fall within the scope of the claims appended hereto. The positional references adopted in the description such as for example up, down, lateral and so forth are also related to the directly described and illustrated Figure and are to be appropriately transferred to the new position upon a change in position.

1. A rail system for drawers, comprising a carcass rail to be fastened to a furniture carcass and at least one drawer rail movable relative to the carcass rail, and at least one rack arranged on a rail of the rail system, wherein the rack is pivotable or bendable with respect to the rail to which it is fastened about a notional axis extending in the extension direction of the rail and is thus mounted limitedly movably heightwise.

2. The rail system according to claim 1, wherein the rack is mounted limitedly movably heightwise by way of a resiliently yielding portion.

3. The rail system according to claim 1, wherein the rack is connected to one of the rails by way of a film hinge.

4. The rail system according to claim 1, wherein the rack is arranged or provided on an adaptor, wherein the adaptor is connected or can be releasably connected to one of the rails by way of at least one fastening location.

5. The rail system according to claim 4, wherein the adaptor is substantially in the form of an L-profile, wherein in the mounted position a leg of the L-profile bears against a vertical limb of the carcass rail and another leg of the L-profile bears against a horizontal limb of the carcass rail.

6. The rail system according to claim 4, wherein the adaptor can be screwed for appropriate mounting to the rail system between the carcass rail and the furniture carcass.

7. The rail system according to claim 1, wherein there is provided at least one pinion engaging into the rack.

8. The rail system according to claim 7, wherein the rack is arranged on the carcass rail and the pinion is mounted on the drawer rail or the drawer.

9. The rail system according to claim 7, wherein the rack is arranged on the drawer rail and the pinion is mounted on the carcass rail or the furniture carcass.

10. The rail system according to claim 7, wherein there is provided a limiting device which limits the depth of engagement of the pinion relative to the rack, wherein the teeth of the pinion only partially engage into the corresponding tooth gaps of the rack.

11. The rail system according to claim 10, wherein the limiting device has a runner wheel which runs on a running surface of a part arranged in the longitudinal direction of the rail system.

12. The rail system according to claim 11, wherein the runner wheel is mounted coaxially relative to the axis of rotation of the pinion.

13. The rail system according to claim 10, wherein the limiting device has at least one limb which engages under the rack and by which the lift-off height of the pinion relative to the rack can be limited.

14. An arrangement comprising two rail systems according to claim 1, wherein the two rail systems are to be fastened to opposite side walls of an article of furniture and the rail systems are or can be connected together for the transmission of a synchronous movement by way of a synchronisation bar, wherein at least one respective pinion engages into a respective rack of the rail system.

15. An article of furniture comprising an arrangement according to claim 14.
